(19) United States
(12) Patent Application Publication
(10) Pub. No.: US 2026/0271146 A1
(43) Pub. Date: Sep. 10, 2026

(54) BRIGHTNESS CONTROL METHOD OF LIGHT-EMITTING DEVICE AND LIGHT-EMITTING MODULE

(71) Applicant: Wuxi Indie Microelectronics Ltd., Wuxi (CN)

(72) Inventors: Jikuai Pan, Wuxi (CN); Jian Zhuang, Wuxi (CN)

(21) Appl. No.: 19/073,779

(22) Filed: Mar. 7, 2025

(51) Int. Cl. H05B 45/10; H05B 45/305; H05B 45/325; H05B 45/345; H05B 45/59; H05B 47/16

(52) U.S. Cl. CPC H05B 45/10; H05B 45/305; H05B 45/325; H05B 45/345; H05B 45/59; H05B 47/16

(57) ABSTRACT

Provided are a brightness control method of a light-emitting device and a light-emitting system. The method includes determining the control cycle of a pulse width modulation signal according to the equivalent bit count of the pulse width modulation signal and the physical bit count of the pulse width modulation signal, where the control cycle includes at least two physical cycles of the pulse width modulation signal, and the number of physical cycles in the control cycle is a value corresponding to the power of 2; determining the actual output value of each physical cycle in the control cycle according to the target output value of the pulse width modulation signal and the control cycle of the pulse width modulation signal; and controlling the brightness of the light-emitting device according to the actual output value.

### TECHNICAL FIELD

Examples of the present disclosure relate to the technical field of electronic circuits, particularly a brightness control method of a light-emitting device and a light-emitting module or system.

### BACKGROUND

In the related art, a light-emitting module can control the on/off operation of a switch by using a pulse-width modulation (PWM) signal output through a PWM control chip, thereby controlling the time the constant current source provides current to a light-emitting diode (LED), adjusting the emission time of the LED, and consequently controlling the brightness of the light-emitting module. The PWM control chip is equipped with a system clock for providing clock signals for a PWM unit in the PWM control chip. Considering factors such as cost, design difficulty, and electromagnetic compatibility, the frequency of the system clock is not very high. The frequency of the system clock affects the frequency of the PWM signal output by the PWM control chip. Generally, the factors affecting the frequency of the PWM signal include the frequency of the system clock and the resolution of the PWM signal. The control frequency of the LED is limited by the frequency of the PWM signal. Illustratively, when the frequency of the system clock is 16 MHz, if the resolution of the PWM is 16 bits, the control frequency of the LED is 16000000/2\hat{ }=244 Hz; or if the resolution of the PWM is 15 bits, the control frequency of the LED is 16000000/2\hat{ }=488 Hz. When the frequency of the system clock is unchanged, the resolution of the PWM signal is smaller, that is, the bit count of the PWM is smaller, and the control frequency of the LED is higher.

As the requirements for light-emitting modules increase, the demand for higher LED control frequencies also rises, requiring a smaller resolution of the PWM. However, the resolution of the PWM affects the brightness adjustment fineness of the LED. The lower the resolution of the PWM, the poorer the brightness adjustment fineness of the LED. Illustratively, when the light-emitting module includes red, green, and blue LEDs, the light-emitting module can mix light from the red, green, and blue LEDs to produce different light emission colors. When the bit count of the PWM is low, resulting in a lower resolution of the PWM, color differences occur in the light mixing of the light-emitting module. Especially when the brightness of the light-emitting module is low, significant color differences occur, thereby reducing the quality of the light mixing in the light-emitting module.

### SUMMARY

The present disclosure provides a brightness control method of a light-emitting device and a light-emitting module to improve the brightness adjustment fineness of the light-emitting device while ensuring the control frequency of the light-emitting device.

An example of the present disclosure provides a brightness control method of a light-emitting device.

The method includes determining the power of 2 (e.g. a first value) according to a difference between an equivalent bit count of a pulse width modulation signal and a physical bit count of the pulse width modulation signal; determining the control cycle of the pulse width modulation signal according to a value corresponding to the power of 2, where the control cycle includes at least two physical cycles of the pulse width modulation signal, and the number of physical cycles in the control cycle (e.g., the second value) is a value corresponding to the power of 2; determining an actual output value of each physical cycle in the control cycle according to a target output value of the pulse width modulation signal and the control cycle of the pulse width modulation signal; and controlling brightness of the light-emitting device according to the actual output value.

In one or more examples, determining the actual output value of each physical cycle in the control cycle according to the target output value of the pulse width modulation signal and the control cycle of the pulse width modulation signal includes determining the actual output value of each physical cycle according to the quotient and the remainder of the target output value and the number of physical cycles in the control cycle.

In one or more examples, determining the actual output value of each physical cycle according to the quotient and the remainder of the target output value and the number of physical cycles in the control cycle includes: if the remainder of the target output value divided by the number of physical cycles in the control cycle is zero, determining that the actual output value of each physical cycle is the quotient of the target output value divided by the number of physical cycles in the control cycle; or if the remainder of the target output value divided by the number of physical cycles in the control cycle is not zero, determining that the actual output value of each of the remainder number of physical cycles in the control cycle is 1 plus the quotient of the target output value divided by the number of physical cycles in the control cycle and that the actual output value of each of the other physical cycles in the control cycle is the quotient of the target output value divided by the number of physical cycles in the control cycle.

In one or more examples, determining that the actual output value of each of the remainder number of physical cycles in the control cycle is 1 plus the quotient of the target output value divided by the number of physical cycles in the control cycle includes determining the remainder number of physical cycles cyclically at equal intervals in the order of the physical cycles.

In one or more examples, determining the remainder number of physical cycles cyclically at the equal intervals in the order of the physical cycles includes: if the remainder is less than or equal to the number of even-numbered physical cycles in the control cycle, determining, according to the order of the physical cycles in the control cycle, that the actual output value of each of the remainder number of even-numbered physical cycles in the control cycle is 1 plus the quotient of the target output value divided by the number of physical cycles in the control cycle; or if the remainder is greater than the number of even-numbered physical cycles in the control cycle, first determining, according to the order of the physical cycles in the control cycle, that the actual output value of each of the even-numbered physical cycles in the control cycle is 1 plus the quotient of the target output value divided by the number of physical cycles in the control cycle, and then sequentially determining that the actual output value of an odd-numbered physical cycle in the control cycle is 1 plus the quotient of the target output value divided by the number of physical cycles in the control cycle until the actual output value of each of the remainder number of physical cycles in the control cycle being 1 plus the quotient of the target output value divided by the number of physical cycles in the control cycle is determined.

Alternatively, if the remainder is less than or equal to the number of odd-numbered physical cycles in the control cycle, determining, according to the order of the physical cycles in the control cycle, that the actual output value of each of the first remainder number of odd-numbered physical cycles in the control cycle is 1 plus the quotient of the target output value divided by the number of physical cycles in the control cycle; or if the remainder is greater than the number of odd-numbered physical cycles in the control cycle, first determining, according to the order of the physical cycles in the control cycle, that the actual output value of each of the odd-numbered physical cycles in the control cycle is 1 plus the quotient of the target output value divided by the number of physical cycles in the control cycle, and then sequentially determining that the actual output value of an even-numbered physical cycle in the control cycle is 1 plus the quotient of the target output value divided by the number of physical cycles in the control cycle until the actual output value of each of the remainder number of physical cycles in the control cycle being 1 plus the quotient of the target output value divided by the number of physical cycles in the control cycle is determined.

In one or more examples, in determining the actual output value of each physical cycle in the control cycle according to the target output value of the pulse width modulation signal and the control cycle of the pulse width modulation signal, the method also includes, if the target output value is within the value range corresponding to the physical bit count, determining that the control cycle is a physical cycle and that the target output value of the pulse width modulation signal is the actual output value of the physical cycle.

In one or more examples, controlling the brightness of the light-emitting device according to the actual output value includes controlling the light emission time of the light-emitting device according to the actual output value.

An example of the present disclosure provides a brightness control apparatus of a light-emitting device. The apparatus is configured to perform the preceding brightness control method of the light-emitting device. The apparatus includes a difference determination module, a cycle determination module, an output value determination module, and a control module.

The difference determination module is configured to determine the power of 2 according to the difference between the equivalent bit count of a pulse width modulation signal and the physical bit count of the pulse width modulation signal.

The cycle determination module is configured to determine the control cycle of the pulse width modulation signal according to a value corresponding to the power of 2, where the control cycle includes at least two physical cycles of the pulse width modulation signal, and the number of the physical cycles is a value corresponding to the power of 2.

The output value determination module is configured to determine the actual output value of each physical cycle in the control cycle according to the target output value of the pulse width modulation signal and the control cycle of the pulse width modulation signal.

The control module is configured to control the brightness of the light-emitting device according to the actual output value.

An example of the present disclosure further provides a light-emitting module. The light-emitting module includes a constant current source, a controllable switch, a light-emitting device, and the preceding brightness control apparatus of the light-emitting device.

The brightness control apparatus of the light-emitting device is connected or coupled to a control terminal of the controllable switch. The controllable switch, the constant current source, and the light-emitting device are connected or coupled between a power terminal and a ground terminal. The brightness control apparatus of the light-emitting device is configured to control the conduction state of the controllable switch.

In the solutions of examples of the present disclosure, the control cycle of the pulse width modulation signal is determined according to the physical bit count and the equivalent bit count of the pulse width modulation signal, and then the actual output value of each physical cycle in the control cycle is determined according to the control cycle and the target output value of the pulse width modulation signal so that the sum of the actual output values of the physical cycles in the control cycle is equal to the target output value. The value range of the target output value can be extended from the value range of the physical bit count of the pulse width modulation signal to the value range of the equivalent bit count of the pulse width modulation signal. In this manner, the value range of the pulse width modulation signal corresponding to the same brightness range of the light-emitting device can be increased so that the brightness adjustment fineness of the light-emitting device corresponding to the target output value can be improved under the condition that the brightness range of the light-emitting device is fixed. Moreover, the control frequency of the light-emitting device may be determined by the physical bit count of the pulse width modulation signal and the frequency of the system clock so that the control frequency of the light-emitting device can be kept unchanged. In this manner, the brightness adjustment fineness of the light-emitting device can be improved while the control frequency of the light-emitting device is maintained.

### BRIEF DESCRIPTION OF DRAWINGS

FIG. 1 is a flowchart of a brightness control method of a light-emitting device according to an example of the present disclosure.

FIG. 2 is a flowchart of a brightness control method of a light-emitting device according to an example of the present disclosure.

FIG. 3 is a diagram illustrating the structure of a brightness control apparatus of a light-emitting device according to an example of the present disclosure.

FIG. 4 is a diagram illustrating the structure of a light-emitting module according to an example of the present disclosure.

### DETAILED DESCRIPTION

The present disclosure is described hereinafter in detail in conjunction with drawings and examples. It is to be understood that the examples described herein are intended to explain the present disclosure and not to limit the present disclosure. Additionally, it is to be noted that for ease of description, only part, not all, of the structures related to the present disclosure are illustrated in the drawings.

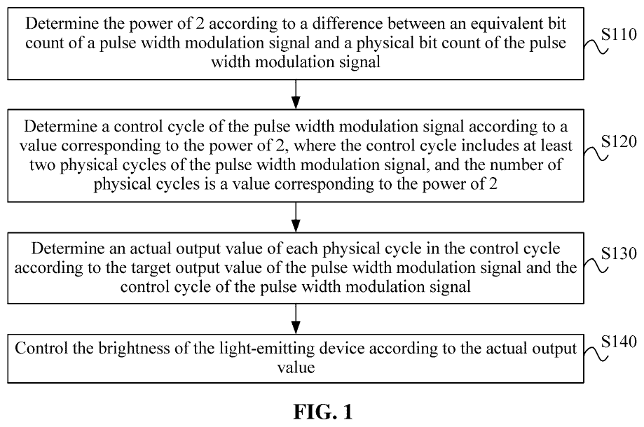

FIG. 1 is a flowchart of a brightness control method of a light-emitting device according to an example of the present disclosure. This example is applicable to brightness control of the light-emitting device by using a PWM signal. The method may be performed by a brightness control apparatus of the light-emitting device. As shown in FIG. 1, the method includes the following steps:

In S110, the power of 2 is determined according to a difference between an equivalent bit count of a pulse width modulation signal and a physical bit count of the pulse width modulation signal.

The pulse width modulation signal may be generated by a pulse width modulation control chip to control the light emission time of the light-emitting device so that the brightness of the light-emitting device can be adjusted. The physical bit count of the pulse width modulation signal is the actual bit count of the pulse width modulation signal and is configured to determine the actual resolution of the pulse width modulation signal. The control frequency of the light-emitting device is determined by the physical bit count of the pulse width modulation signal and the frequency of the system clock. For example, the physical bit count of the pulse width modulation signal may be m bits. When the clock frequency is X Hz, the control frequency of the light-emitting device is (X/2\hat{ }m) Hz. The equivalent bit count of the pulse width modulation signal is a bit count corresponding to the target resolution of the pulse width modulation signal. The equivalent bit count of the pulse width modulation signal is greater than the physical bit count of the pulse width modulation signal to achieve virtual extension of the bit count of the pulse width modulation signal, thereby improving the resolution of the pulse width modulation signal without affecting the control frequency of the light-emitting device. Illustratively, the equivalent bit count of the pulse width modulation signal may be (m+n) bits, where n is an integer greater than or equal to 1, so that the bit count of the pulse width modulation signal is virtually extended by n bits from the physical bit count, thereby increasing the resolution of the pulse width modulation signal without affecting the control frequency of the light-emitting device. The physical cycle of the pulse width modulation signal is a cycle corresponding to the physical bit count of the pulse width modulation signal. Illustratively, the pulse width modulation control chip includes a counter configured to perform counting based on the value range corresponding to the physical bit count of the pulse width modulation signal and determine the physical cycle of the pulse width modulation signal based on the counting period. For example, when the physical bit count of the pulse width modulation signal is m bits, the physical cycle of the pulse width modulation signal is the time required for the counter to count from 0 to 2\hat{ }m−1. The control cycle of the pulse width modulation signal is a cycle corresponding to the equivalent bit count of the pulse width modulation signal. The value range of the pulse width modulation signal output by the pulse width modulation control chip corresponds to the physical bit count. When the equivalent bit count of the pulse width modulation signal is greater than the physical bit count of the pulse width modulation signal, the pulse width modulation control chip requires multiple physical cycles for outputting the pulse width modulation signal whose value exceeds the value range corresponding to the physical bit count so that the control cycle of the pulse width modulation signal includes at least two physical cycles of the pulse width modulation signal.

The actual output value range of the pulse width modulation signal is the same as the value range of the physical bit count of the pulse width modulation signal, that is, 0 to 2\hat{ }m−1. m denotes the physical bit count of the pulse width modulation signal. The equivalent output value range of the pulse width modulation signal is the same as the value range of the equivalent bit count of the pulse width modulation signal, that is, 0 to 2\hat{ }(m+n)−1. Here (m+n) is the equivalent bit count of the pulse width modulation signal. In this case, the equivalent output value range of the pulse width modulation signal is 2\hat{ }n times of the actual output value range. That is, the difference between the physical bit count and the equivalent bit count of the pulse width modulation signal is used as the value corresponding to the power of 2. After the physical bit count and the equivalent bit count of the pulse width modulation signal are determined, the difference between the equivalent bit count and the physical bit count may be determined and used as the power of 2. Illustratively, when the physical bit count of the pulse width modulation signal is m bits and the equivalent bit count is (m+n) bits, the power of 2 is n. When the actual output value range of the pulse width modulation signal is relatively large, the control cycle corresponds to a relatively large number of physical cycles.

In S120, the control cycle of the pulse width modulation signal is determined according to a value corresponding to the power of 2. The control cycle includes at least two physical cycles of the pulse width modulation signal, and the number of physical cycles is the value corresponding to the power of 2.

After the power of 2 is determined, the value corresponding to the power of 2 may be determined. Illustratively, as described earlier, when the power of 2 is n, the value corresponding to the power of 2 is 2\hat{ }n. In this case, it may be determined that the control cycle of the pulse width modulation signal is 2\hat{ }n physical cycles. By configuring the control cycle to include 2\hat{ }n physical cycles, the sum of the actual output values of the 2\hat{ }n physical cycles can cover the value range corresponding to the equivalent bit count of the pulse width modulation signal, thereby extending the value range of the pulse width modulation signal to the value range of the equivalent bit count.

It is to be noted that in other examples, it is also feasible to configure the control cycle to include a multiple of 2\hat{ }n physical cycles to extend the value range of the pulse width modulation signal to the value range of the equivalent bit count. This is not limited herein.

In S130, an actual output value of each physical cycle in the control cycle is determined according to the target output value of the pulse width modulation signal and the control cycle of the pulse width modulation signal.

The target output value of the pulse width modulation signal is the value of the brightness of the corresponding light-emitting device output by the pulse width modulation control signal. The value range of the target output value may be the same as the value range of the equivalent bit count of the pulse width modulation signal. Illustratively, when the equivalent bit count of the pulse width modulation signal is (m+n) bits, the value range of the target output value is from 0 to 2\hat{ }(m+n)−1. The larger the target output value of the pulse width modulation signal, the greater the brightness of the corresponding light-emitting device. After the target output value of the pulse width modulation signal is determined, the actual output value of each physical cycle in the control cycle may be determined according to the target output value and the control cycle so that the sum of the actual output values of the physical cycles in the control cycle is equal to the target output value. The value range of the target output value can be extended from the value range of the physical bit count of the pulse width modulation signal to the value range of the equivalent bit count of the pulse width modulation signal so that the value range of the pulse width modulation signal corresponding to the same brightness range of the light-emitting device can be increased; thus, the brightness adjustment fineness of the light-emitting device corresponding to the target output value can be improved under the condition of a fixed brightness range of the light-emitting device.

In S140, the brightness of the light-emitting device is controlled according to the actual output value.

After the actual output value of each physical cycle in the control cycle is determined, the corresponding pulse width modulation signal can be output according to the actual output value of each physical cycle so that the pulse width modulation signal corresponding to the target output value can be output in the control cycle; thus, the brightness of the light-emitting device in the control cycle can match the target output value so that the brightness of the light-emitting device can be controlled.

In the solution of this example, the control cycle of the pulse width modulation signal is determined according to the physical bit count and the equivalent bit count of the pulse width modulation signal, and then the actual output value of each physical cycle in the control cycle is determined according to the target output value of the pulse width modulation signal and the control cycle of the pulse width modulation signal so that the sum of the actual output values of the physical cycles in the control cycle is equal to the target output value. The value range of the target output value can be extended from the value range of the physical bit count of the pulse width modulation signal to the value range of the equivalent bit count of the pulse width modulation signal. In this manner, the value range of the pulse width modulation signal corresponding to the same brightness range of the light-emitting device can be increased so that the brightness adjustment fineness of the light-emitting device corresponding to the target output value can be improved under the condition of a fixed brightness range of the light-emitting device. Moreover, the control frequency of the light-emitting device may be determined by the physical bit count of the pulse width modulation signal and the frequency of the system clock so that the control frequency of the light-emitting device can be kept unchanged. In this manner, the brightness adjustment fineness of the light-emitting device can be improved while the control frequency of the light-emitting device is maintained.

Based on the previous solution, controlling the brightness of the light-emitting device according to the actual output value includes controlling the light emission time of the light-emitting device according to the actual output value.

The actual output value of the pulse width modulation signal can adjust the duty cycle of the pulse width modulation signal so that the on time of the path where the light-emitting device is located can be controlled, that is, the light emission time of the light-emitting device can be controlled; thus, the brightness of the light-emitting device can be controlled.

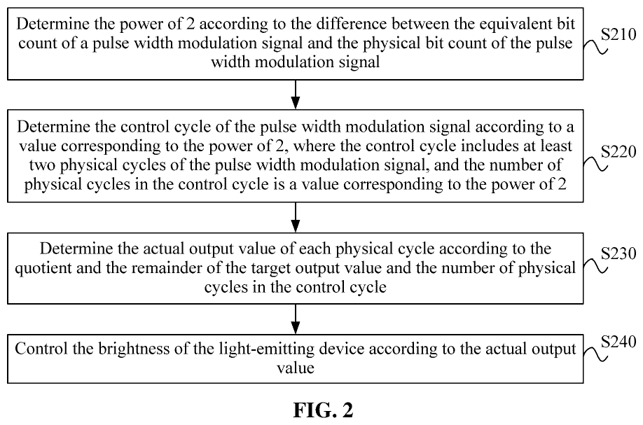

FIG. 2 is a flowchart of a brightness control method of a light-emitting device according to an example of the present disclosure.

In S210, the power of 2 is determined according to a difference between an equivalent bit count of a pulse width modulation signal and a physical bit count of the pulse width modulation signal.

In S220, the control cycle of the pulse width modulation signal is determined according to a value corresponding to the power of 2. The control cycle includes at least two physical cycles of the pulse width modulation signal, and the number of physical cycles is a value corresponding to the power of 2.

In S230, the actual output value of each physical cycle is determined according to the quotient and the remainder of the target output value and the number of physical cycles in the control cycle.

The sum of the actual output values of the physical cycles in the control cycle is the target output value. When the control cycle includes multiple physical cycles, the actual output value of each physical cycle may be determined according to the quotient and the remainder of the target output value and the number of physical cycles in the control cycle so that the difference between the actual output values of different physical cycles is relatively small, thereby reducing the brightness difference of the light-emitting device corresponding to different physical cycles and alleviating flickers of the light-emitting device.

In one or more examples, determining the actual output value of each physical cycle according to the quotient and the remainder of the target output value and the number of physical cycles in the control cycle includes, if the remainder of the target output value divided by the number of physical cycles in the control cycle is zero, determining that the actual output value of each physical cycle is the quotient of the target output value divided by the number of physical cycles in the control cycle.

When the remainder of the target output value divided by the number of physical cycles in the control cycle is zero, the actual output value of each physical cycle is the average of the target output value in each physical cycle so that the brightness of the light-emitting device corresponding to different physical cycles is consistent, thereby reducing the probability that the light-emitting device flickers between different physical cycles. Illustratively, when the target output value is M and the control cycle includes 2\hat{ }n physical cycles, the quotient of the target output value divided by the number of physical cycles in the control cycle is AVG=M/2\hat{ }n, and the remainder R is M-AVG. When the remainder R is 0, the actual output value of each different physical cycle is the average AVG=M/2\hat{ }n of the target output value in each physical cycle.

Alternatively, determining the actual output value of each physical cycle according to the quotient and the remainder of the target output value and the number of physical cycles in the control cycle includes, if the remainder of the target output value divided by the number of physical cycles in the control cycle is not zero, determining that the actual output value of each of the remainder number of physical cycles in the control cycle is 1 plus the quotient of the target output value divided by the number of physical cycles in the control cycle and that the actual output value of each of the other physical cycles in the control cycle is the quotient of the target output value divided by the number of physical cycles in the control cycle.

When the remainder of the target output value divided by the number of physical cycles in the control cycle is not zero, the remainder may be added to the remainder number of physical cycles separately based on the average of the target output value in each physical cycle so that the actual output value of each of the remainder number of physical cycles is the average plus 1, and the actual output value of each of the other physical cycles is still the average, thereby ensuring that the difference between the actual output values of different physical cycles is relatively small to the greatest extent and reducing the probability that the light-emitting device flickers between different physical cycles.

In S240, the brightness of the light-emitting device is controlled according to the actual output value.

Based on the previous solution, determining that the actual output value of each of the remainder number of physical cycles in the control cycle is 1 plus the quotient of the target output value divided by the number of physical cycles in the control cycle includes determining the remainder number of physical cycles cyclically at equal intervals in the order of the physical cycles.

When the actual output value has a remainder after being divided by the number of physical cycles in the control cycle and the remainder is evenly allocated to the remainder number of physical cycles, it is feasible to determine the remainder number of physical cycles at equal intervals according to the order of the physical cycles to evenly allocate the remainder. In this manner, the regularity of the target output value between different physical cycles can be improved so that the regularity of the brightness of the light-emitting device corresponding to different physical cycles can be improved, and flickers of the light-emitting device corresponding to different physical cycles can be alleviated. Illustratively, when the control cycle includes 2\hat{ }n physical cycles, it is feasible to select the remainder number of physical cycles at equal intervals in the order of the physical cycles from the first physical cycle to the (2\hat{ }n)^{th} physical cycle so that the actual output value for these physical cycles is 1 plus the quotient of the target output value divided by the number of physical cycles in the control cycle and the actual output value of each of the other physical cycles is the quotient of the target output value divided by the number of physical cycles in the control cycle. When the number of physical cycles selected at equal intervals from the first physical cycle to the (2\hat{ }n)^{th} physical cycle is less than the remainder, the selection process may be repeated, and physical cycles whose actual output value is still equal to the average are selected at equal intervals until the remainder number of physical cycles are selected. Illustratively, when n is 2, the control cycle includes 4 physical cycles, and the remainder is 3; if the selection starts with the first physical cycle and the actual output value of the first physical cycle is the average plus 1, with intervals of 2, then the actual output value of the fourth physical cycle is the average plus 1, each of the two physical cycles selected from the four physical cycles has an actual output value of the average plus 1, and the number of selected physical cycles is less than 3. Thus, the selection process may be repeated starting from the second physical cycle so that the actual output value of this physical cycle is the average plus 1, that is, the actual output value of the second physical cycle is the average plus 1. At this point, three physical cycles are selected from the four physical cycles and each has the actual output value of the average plus 1, the number of selected physical cycles is equal to the remainder. Thus, the final actual output values of the four physical cycles are the average plus 1, the average plus 1, the average, and the average plus 1 respectively.

In one or more examples, determining the remainder number of physical cycles cyclically at the equal intervals in the order of the physical cycles includes, if the remainder is less than or equal to the number of even-numbered physical cycles in the control cycle, determining, according to the order of the physical cycles in the control cycle, that the actual output value of each of the remainder number of even-numbered physical cycles in the control cycle is 1 plus the quotient of the target output value divided by the number of physical cycles in the control cycle; or if the remainder is greater than the number of even-numbered physical cycles in the control cycle, first determining, according to the order of the physical cycles in the control cycle, that the actual output value of each of the even-numbered physical cycles in the control cycle is 1 plus the quotient of the target output value divided by the number of physical cycles in the control cycle, and then sequentially determining, according to the order of the physical cycles in the control cycle, that the actual output value of an odd-numbered physical cycle in the control cycle is 1 plus the quotient of the target output value divided by the number of physical cycles in the control cycle until the actual output value of each of the remainder number of physical cycles in the control cycle being 1 plus the quotient of the target output value divided by the number of physical cycles in the control cycle is determined.

The order of the physical cycles may be the first physical cycle, the second physical cycle, . . . , the (2\hat{ }n)^{th} physical cycle in sequence. In this case, half of the sequence numbers of the physical cycles are even numbers, and the other half of the sequence numbers of the physical cycles are odd numbers. When the remainder is less than half of the number of physical cycles, the remainder is less than the number of even-numbered physical cycles, that is, the number of even-numbered physical cycles is greater than the remainder. In this case, the interval may be set to 1, and the remainder number of physical cycles are selected from the even-numbered physical cycles so that the actual output value of each of the remainder number of even-numbered physical cycles is the average plus 1. When the remainder is greater than half of the number of physical cycles, the remainder is greater than the number of even-numbered physical cycles, that is, the number of even-numbered physical cycles is less than the remainder. In this case, the interval may be set to 1, and the actual output value is set to the average plus 1 starting from the even-numbered physical cycles. Then, the difference between the remainder and half of the physical cycles is determined, and the actual output value of each of the difference number of odd-numbered physical cycles is set to the average plus 1. Thus, the actual output value of each of the remainder number of physical cycles is determined as the average plus 1. Illustratively, when the physical bit count of the pulse width modulation signal is 10 bits, the actual output value range is 0 to 1023; when the equivalent bit count of the pulse width modulation signal is 12 bits, the equivalent output value range is 0 to 4095. If the target output value of the pulse width modulation signal is 2047, it is feasible to first determine that the control cycle includes 2\hat{ }2=4 physical cycles, the quotient of the target output value divided by the number of physical cycles in the control cycle is AVG=2047/2\hat{ }2=511, and the remainder R is 3. In this case, it is feasible to determine that the actual output value of each of two even-numbered physical cycles is 511+1=512, determine that the actual output value of the first odd-numbered physical cycle is 511+1=512, and then determine that the actual output value of the remaining odd-numbered physical cycle is 511. In this case, the actual output values of the four physical cycles are 512, 512, 511, and 512 respectively.

Alternatively, if the remainder is less than or equal to the number of odd-numbered physical cycles in the control cycle, determining, according to the order of the physical cycles in the control cycle, that the actual output value of each of the first remainder number of odd-numbered physical cycles in the control cycle is 1 plus the quotient of the target output value divided by the number of physical cycles in the control cycle; or if the remainder is greater than the number of odd-numbered physical cycles in the control cycle, first determining, according to the order of the physical cycles in the control cycle, that the actual output value of each of the odd-numbered physical cycles in the control cycle is 1 plus the quotient of the target output value divided by the number of physical cycles in the control cycle, and then sequentially determining, according to the order of the physical cycles in the control cycle, that the actual output value of an even-numbered physical cycle in the control cycle is 1 plus the quotient of the target output value divided by the number of physical cycles in the control cycle until the actual output value of each of the remainder number of physical cycles in the control cycle being 1 plus the quotient of the target output value divided by the number of physical cycles in the control cycle is determined.

In this example, it is feasible to select the remainder number of physical cycles from the odd-numbered physical cycles. When the remainder is less than half of the number of physical cycles, the remainder is less than the number of odd-numbered physical cycles, that is, the number of odd-numbered physical cycles is greater than the remainder. In this case, the interval may be set to 1, and the remainder number of physical cycles are selected from the odd-numbered physical cycles so that the actual output value of each of the remainder number of odd-numbered physical cycles is the average plus 1. When the remainder is greater than half of the number of physical cycles, the remainder is greater than the number of odd-numbered physical cycles, that is, the number of odd-numbered physical cycles is less than the remainder. In this case, the interval may be set to 1, and the actual output value is set to the average plus 1 starting from the odd-numbered physical cycles. Then, the difference between the remainder and half of the physical cycles is determined, and the actual output value of each of the difference number of even-numbered physical cycles is set to the average plus 1. Thus, the actual output value of each of the remainder number of physical cycles is determined as the average plus 1. Illustratively, when the physical bit count of the pulse width modulation signal is 10 bits, the actual output value range is 0 to 1023; when the equivalent bit count of the pulse width modulation signal is 12 bits, the equivalent output value range is 0 to 4095. If the target output value of the pulse width modulation signal is 2047, it is feasible to first determine that the control cycle includes 2\hat{ }2=4 physical cycles, the quotient of the target output value divided by the number of physical cycles in the control cycle is AVG=2047/2\hat{ }2=511, and the remainder R is 3. In this case, it is feasible to determine that the actual output value of each of the two odd-numbered physical cycles is 511+1=512, determine that the actual output value of the first even-numbered physical cycle is 511+1=512, and then determine that the actual output value of the remaining even-numbered physical cycle is 511. In this case, the actual output values of the four physical cycles are 512, 512, 512, and 511 respectively.

In one or more examples, when determining the actual output value of each physical cycle in the control cycle according to the target output value of the pulse width modulation signal and the control cycle of the pulse width modulation signal, the method also includes: if the target output value is within the value range corresponding to the physical bit count, determining that the control cycle is a physical cycle and that the target output value of the pulse width modulation signal is the actual output value of the physical cycle.

When the target output value is within the value range corresponding to the physical bit count, the value output range corresponding to the physical cycle of the pulse width modulation signal is the target output value. In this case, it may be directly determined that the control cycle includes one physical cycle, and the actual output value of the physical cycle is determined as the target output value. Thus, the target output value of the pulse width modulation signal is directly output through one physical cycle. Moreover, on the basis that the actual output value of the pulse width modulation signal matches the target output value, the calculation amount can be reduced, the performance requirement of the pulse width modulation control chip can be reduced, the brightness delay of the light-emitting device can be reduced, and flickers caused by the difference between actual output values of different physical cycles can be prevented.

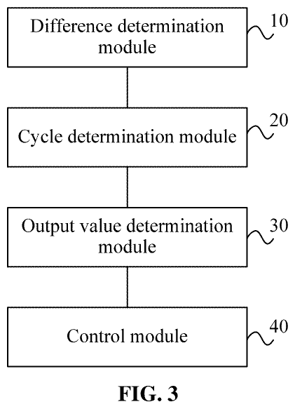

An example of the present disclosure provides a brightness control apparatus of a light-emitting device. The apparatus is configured to perform the brightness control method of the light-emitting device according to any example of the present disclosure. FIG. 3 is a diagram illustrating the structure of a brightness control apparatus of a light-emitting device according to an example of the present disclosure. As shown in FIG. 3, the apparatus includes a difference determination module 10, a cycle determination module 20, an output value determination module 30, and a control module 40.

The difference determination module 10 is configured to determine the power of 2 according to a difference between an equivalent bit count of a pulse width modulation signal and a physical bit count of the pulse width modulation signal.

The cycle determination module 20 is configured to determine a control cycle of the pulse width modulation signal according to a value corresponding to the power of 2, where the control cycle includes at least two physical cycles of the pulse width modulation signal, and the number of physical cycles in the control cycle is a value corresponding to the power of 2.

The output value determination module 30 is configured to determine the actual output value of each physical cycle in the control cycle according to the target output value of the pulse width modulation signal and the control cycle of the pulse width modulation signal.

The control module 40 is configured to control the brightness of the light-emitting device according to the actual output value.

In the solution of this example of the present disclosure, the cycle determination module determines the control cycle of the pulse width modulation signal according to the physical bit count and the equivalent bit count of the pulse width modulation signal, and then the output value determination module determines the actual output value of each physical cycle in the control cycle according to the target output value of the pulse width modulation signal and the control cycle of the pulse width modulation signal so that the sum of the actual output values of the physical cycles in the control cycle is equal to the target output value. The value range of the target output value can be extended from the value range of the physical bit count of the pulse width modulation signal to the value range of the equivalent bit count of the pulse width modulation signal. In this manner, the value range of the pulse width modulation signal corresponding to the same brightness range of the light-emitting device can be increased so that the brightness adjustment fineness of the light-emitting device corresponding to the target output value can be improved under the condition that the brightness range of the light-emitting device is fixed. Moreover, the control frequency of the light-emitting device may be determined by the physical bit count of the pulse width modulation signal and the frequency of the system clock so that the control frequency of the light-emitting device can be kept unchanged. In this manner, the brightness adjustment fineness of the light-emitting device can be improved while the control frequency of the light-emitting device is maintained.

Based on the previous solution, the output value determination module is configured to determine the actual output value of each physical cycle according to the quotient and the remainder of the target output value and the number of physical cycles in the control cycle.

Based on the previous solution, the output value determination module includes a first output value determination unit and a second output value determination unit.

The first output value determination unit is configured to, if the remainder of the target output value divided by the number of physical cycles in the control cycle is zero, determine that the actual output value of each physical cycle is the quotient of the target output value divided by the number of physical cycles in the control cycle.

The second output value determination unit is configured to, if the remainder of the target output value divided by the number of physical cycles in the control cycle is not zero, determine that the actual output value of each of the remainder number of physical cycles in the control cycle is 1 plus the quotient of the target output value divided by the number of physical cycles in the control cycle and that the actual output value of each of other physical cycles in the control cycle is the quotient of the target output value divided by the number of physical cycles in the control cycle.

Based on the previous solution, the second output value determination unit is configured to determine the remainder number of physical cycles cyclically at equal intervals in the order of the physical cycles.

Based on the previous solution, the second output value determination unit is configured to, if the remainder is less than or equal to the number of even-numbered physical cycles in the control cycle, determine, according to the order of the physical cycles in the control cycle, that the actual output value of each of the remainder number of even-numbered physical cycles in the control cycle is 1 plus the quotient of the target output value divided by the number of physical cycles in the control cycle; or if the remainder is greater than the number of even-numbered physical cycles in the control cycle, first determine, according to the order of the physical cycles in the control cycle, that the actual output value of each of the even-numbered physical cycles in the control cycle is 1 plus the quotient of the target output value divided by the number of physical cycles in the control cycle, and then sequentially determine, according to the order of the physical cycles in the control cycle, that the actual output value of an odd-numbered physical cycle in the control cycle is 1 plus the quotient of the target output value divided by the number of physical cycles in the control cycle until the actual output value of each of the remainder number of physical cycles in the control cycle being 1 plus the quotient of the target output value divided by the number of physical cycles in the control cycle is determined.

Alternatively, the second output value determination unit is configured to, if the remainder is less than or equal to the number of odd-numbered physical cycles in the control cycle, determine, according to the order of the physical cycles in the control cycle, that the actual output value of each of the first remainder number of odd-numbered physical cycles in the control cycle is 1 plus the quotient of the target output value divided by the number of physical cycles in the control cycle; or if the remainder is greater than the number of odd-numbered physical cycles in the control cycle, first determine, according to the order of the physical cycles in the control cycle, that the actual output value of each of the odd-numbered physical cycles in the control cycle is 1 plus the quotient of the target output value divided by the number of physical cycles in the control cycle, and then sequentially determine, according to the order of the physical cycles in the control cycle, that the actual output value of an even-numbered physical cycle in the control cycle is 1 plus the quotient of the target output value divided by the number of physical cycles in the control cycle until the actual output value of each of the remainder number of physical cycles in the control cycle being 1 plus the quotient of the target output value divided by the number of physical cycles in the control cycle is determined.

Based on each previous solution, the brightness control apparatus of the light-emitting device also includes a direct determination module.

The direct determination module is configured to, when the output value determination module determines the actual output value of each physical cycle in the control cycle according to the target output value of the pulse width modulation signal and the control cycle of the pulse width modulation signal, if the target output value is within the value range corresponding to the physical bit count, determine that the control cycle is a physical cycle and that the target output value of the pulse width modulation signal is the actual output value of the physical cycle.

Based on each previous solution, the control module is configured to control the light emission time of the light-emitting device according to the actual output value.

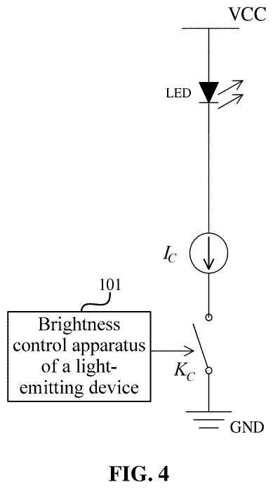

An example of the present disclosure further provides a light-emitting module. FIG. 4 is a diagram illustrating the structure of a light-emitting module according to an example of the present disclosure. As shown in FIG. 4, the light-emitting module includes a constant current source Ic, a controllable switch Kc, a light-emitting diode (LED), and the brightness control apparatus 101 of the light-emitting device according to any example of the present disclosure. The brightness control apparatus 101 of the light-emitting device is connected or coupled to a control terminal of the controllable switch Kc. The controllable switch Kc, the constant current source Ic, and the LED are connected or coupled between a power terminal VCC and a ground terminal GND. The brightness control apparatus 101 of the light-emitting device is configured to control the conduction state of the controllable switch Kc.

In one or more examples, the brightness control apparatus 101 of the light-emitting device may be integrated in a pulse width modulation control chip and is configured to provide a pulse width modulation signal to the control terminal of the controllable switch Kc for controlling the on time of the controllable switch Kc. When the controllable switch Kc is turned on, the path where the LED is located has a current loop, and the LED emits light according to the current provided by the constant current source Ic. It is possible to control the brightness of the LED by controlling the light emission time of the LED according to the on time of the controllable switch Kc. The light-emitting module includes the brightness control apparatus 101 of the light-emitting device according to any example of the present disclosure and thus has the same beneficial effects as the brightness control apparatus 101 of the light-emitting device. The beneficial effects are not repeated here.

It is to be noted that the preceding describes example examples of the present disclosure and technical principles used herein. It is to be understood by those skilled in the art that the present disclosure is not limited to the examples described herein. Those skilled in the art can make various apparent modifications, adaptations, and substitutions without departing from the scope of the present disclosure. Therefore, although the present disclosure has been described in detail through the preceding examples, the present disclosure is not limited to the preceding examples and may include equivalent examples without departing from the concept of the present disclosure. The scope of the present disclosure is determined by the scope of the appended claims.

What is claimed is:

1. A brightness control method of a light-emitting device, comprising:
determining a first value based on a difference between an equivalent bit count of a pulse width modulation signal and a physical bit count of the pulse width modulation signal, wherein the equivalent bit count of the pulse width modulation signal corresponds to a target resolution of the pulse width modulation signal, and the physical bit count of the pulse width modulation signal corresponds to an actual resolution of the pulse width modulation signal, and wherein the first value is a power of 2;
determining a control cycle of the pulse width modulation signal based on a second value corresponding to the first value, wherein the control cycle comprises at least two physical cycles of the pulse width modulation signal, and wherein the second value is a number of the physical cycles;
in response to a target output value of the pulse width modulation signal being greater than a value range corresponding to the physical bit count, determining an actual output value of each physical cycle in the control cycle based on the target output value of the pulse width modulation signal and the control cycle of the pulse width modulation signal; and
controlling brightness of the light-emitting device according to the actual output value.

2. The brightness control method of the light-emitting device according to claim 1, wherein determining the actual output value comprises:
determining the actual output value of each physical cycle based on a quotient and a remainder of the target output value and the second value.

3. The brightness control method of the light-emitting device according to claim 2, wherein determining the actual output value of each physical cycle based on the quotient and the remainder of the target output value and the second value comprises:
in response to the remainder of the target output value divided by the second value being zero, determining that the actual output value of each physical cycle is the quotient of the target output value divided by the second value; or
in response to the remainder of the target output value divided by the second value being non-zero, determining that an actual output value of each of a remainder number of physical cycles in the control cycle is 1 plus the quotient of the target output value divided by the second value and that an actual output value of each of other physical cycles in the control cycle is the quotient of the target output value divided by the second value.

4. The brightness control method of the light-emitting device according to claim 3, wherein determining that the actual output value of each of the remainder number of physical cycles in the control cycle is 1 plus the quotient of the target output value divided by the second value comprises:
determining the remainder number of physical cycles cyclically at equal intervals in an order of the physical cycles.

5. The brightness control method of the light-emitting device according to claim 4, wherein determining the remainder number of physical cycles cyclically at the equal intervals comprises:
in response to the remainder being less than or equal to a number of even-numbered physical cycles in the control cycle, determining, based on the order of the physical cycles in the control cycle, that an actual output value of each of the remainder number of even-numbered physical cycles in the control cycle is 1 plus the quotient of the target output value divided by the second value; or
in response to the remainder being greater than a number of even-numbered physical cycles in the control cycle, first determining, based on the order of the physical cycles in the control cycle, that an actual output value of each of the even-numbered physical cycles in the control cycle is 1 plus the quotient of the target output value divided by the second value, and then sequentially determining, according to the order of the physical cycles in the control cycle, that an actual output value of an odd-numbered physical cycle in the control cycle is 1 plus the quotient of the target output value divided by the second value until the actual output value of each of the remainder number of physical cycles in the control cycle being 1 plus the quotient of the target output value divided by the second value is determined.

6. The brightness control method of the light-emitting device according to claim 4, wherein determining the remainder number of physical cycles cyclically at the equal intervals comprises:
in response to the remainder being less than or equal to a number of odd-numbered physical cycles in the control cycle, determining, based on the order of the physical cycles in the control cycle, that an actual output value of each of the remainder number of odd-numbered physical cycles in the control cycle is 1 plus the quotient of the target output value divided by the second value; or
in response to the remainder being greater than a number of odd-numbered physical cycles in the control cycle, first determining, based on the order of the physical cycles in the control cycle, that an actual output value of each of the odd-numbered physical cycles in the control cycle is 1 plus the quotient of the target output value divided by the second value, and then sequentially determining, based on the order of the physical cycles in the control cycle, that an actual output value of an even-numbered physical cycle in the control cycle is 1 plus the quotient of the target output value divided by the second value until the actual output value of each of the remainder number of physical cycles in the control cycle being 1 plus the quotient of the target output value divided by the second value is determined.

7. The brightness control method of the light-emitting device according to claim 1, wherein determining the actual output value comprises:
in response to the target output value being within the value range corresponding to the physical bit count, determining that the control cycle is a physical cycle and that the target output value of the pulse width modulation signal is an actual output value of the physical cycle.

8. The brightness control method of the light-emitting device according to claim 1, wherein controlling the brightness of the light-emitting device comprises:
controlling light emission time of the light-emitting device based on the actual output value.

9. A light-emitting system, comprising:
a constant current source,
a controllable switch,
a light-emitting device, and
a brightness control apparatus of the light-emitting device,
wherein the brightness control apparatus is coupled to a control terminal of the controllable switch; the controllable switch, the constant current source, and the light-emitting device are coupled between a power terminal and a ground terminal; and the brightness control apparatus of the light-emitting device is configured to control a conduction state of the controllable switch;
wherein the brightness control apparatus of the light-emitting device is configured to perform the following:
determining a first value based on a difference between an equivalent bit count of a pulse width modulation signal and a physical bit count of the pulse width modulation signal, wherein the equivalent bit count of the pulse width modulation signal corresponds to a target resolution of the pulse width modulation signal, and the physical bit count of the pulse width modulation signal corresponds to an actual resolution of the pulse width modulation signal, and wherein the first value is a power of 2;
determining a control cycle of the pulse width modulation signal according to a second value corresponding to the first value, wherein the control cycle comprises at least two physical cycles of the pulse width modulation signal, and wherein the second value is a number of the physical cycles corresponding to the first value;
in response to a target output value of the pulse width modulation signal being greater than a value range corresponding to the physical bit count, determining an actual output value of each physical cycle in the control cycle based on the target output value of the pulse width modulation signal and the control cycle of the pulse width modulation signal; and
controlling brightness of the light-emitting device based on the actual output value.

10. The light-emitting system according to claim 9, wherein the brightness control apparatus is configured to determine the actual output value by:
determining the actual output value of each physical cycle based on a quotient and a remainder of the target output value and the second value.

11. The light-emitting system according to claim 10, wherein the brightness control apparatus of the light-emitting device is configured to determine the actual output value of each physical cycle according to the quotient and the remainder of the target output value and the second value by:
in response to the remainder of the target output value divided by the second value being zero, determining that the actual output value of each physical cycle is the quotient of the target output value divided by the second value; or
in response to the remainder of the target output value divided by the second value being non-zero, determining that an actual output value of each of a remainder number of physical cycles in the control cycle is 1 plus the quotient of the target output value divided by the second value and that an actual output value of each of other physical cycles in the control cycle is the quotient of the target output value divided by the second value.

12. The light-emitting system according to claim 11, wherein the brightness control apparatus is configured to determine that the actual output value of each of the remainder number of physical cycles in the control cycle is 1 plus the quotient of the target output value divided by the second value by:
determining the remainder number of physical cycles cyclically at equal intervals in an order of the physical cycles.

13. The light-emitting system according to claim 12, wherein the brightness control apparatus is configured to determine the remainder number of physical cycles cyclically at the equal intervals in the order of the physical cycles by:
in response to the remainder being less than or equal to a number of even-numbered physical cycles in the control cycle, determining, based on the order of the physical cycles in the control cycle, that an actual output value of each of the remainder number of even-numbered physical cycles in the control cycle is 1 plus the quotient of the target output value divided by the second value; or
in response to the remainder being greater than a number of even-numbered physical cycles in the control cycle, first determining, based on the order of the physical cycles in the control cycle, that an actual output value of each of the even-numbered physical cycles in the control cycle is 1 plus the quotient of the target output value divided by the second value, and then sequentially determining, based on the order of the physical cycles in the control cycle, that an actual output value of an odd-numbered physical cycle in the control cycle is 1 plus the quotient of the target output value divided by the second value until the actual output value of each of the remainder number of physical cycles in the control cycle being 1 plus the quotient of the target output value divided by the second value is determined.

14. The light-emitting system according to claim 12, wherein the brightness control apparatus is configured to determine the remainder number of physical cycles cyclically at the equal intervals in the order of the physical cycles by:
in response to the remainder being less than or equal to a number of odd-numbered physical cycles in the control cycle, determining, based on the order of the physical cycles in the control cycle, that an actual output value of each of the remainder number of odd-numbered physical cycles in the control cycle is 1 plus the quotient of the target output value divided by the second value; or
in response to the remainder being greater than a number of odd-numbered physical cycles in the control cycle, first determining, based on the order of the physical cycles in the control cycle, that an actual output value of each of the odd-numbered physical cycles in the control cycle is 1 plus the quotient of the target output value divided by the second value, and then sequentially determining, based on the order of the physical cycles in the control cycle, that an actual output value of an even-numbered physical cycle in the control cycle is 1 plus the quotient of the target output value divided by the second value until the actual output value of each of the remainder number of physical cycles in the control cycle being 1 plus the quotient of the target output value divided by the second value is determined.

15. The light-emitting system according to claim 9, wherein the brightness control apparatus is configured to determine the actual output value of each physical cycle in the control cycle by:
in response to the target output value being within the value range corresponding to the physical bit count, determining that the control cycle is a physical cycle and that the target output value of the pulse width modulation signal is an actual output value of the physical cycle.

16. The light-emitting system according to claim 9, wherein the brightness control apparatus is configured to control the brightness of the light-emitting device by:
controlling light emission time of the light-emitting device based on the actual output value.
